(19) United States
(12) Patent Application Publication
(10) Pub. No.: US 2006/0044266 A1
(43) Pub. Date: Mar. 2, 2006

(54) Motion testing method and system for testing optical sensing modules

(75) Inventors: Hou-Ching Chin, Taipei (TW); Chih-Chien Chang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/194,846

(22) Filed: Aug. 1, 2005

(30) Foreign Application Priority Data
Aug. 27, 2004 (TW) 093125923

(51) Int. Cl. G09G 5/00

(52) U.S. Cl. 345/156

(57) ABSTRACT

The present invention discloses a motion testing method and system for testing optical sensing modules. A movable light source emitting a light beam projected onto photodetector arrays of the optical sensing modules. When the movable light source is moved under the control of a control signal, speckles formed in the light beam and detected by the photodetdectors will change accordingly. According to the changes of the speckles, moving signals are generated by control circuits of the optical sensing modules. A host computer thus compares each moving signal with the control signal, and determines a normal state when the movement pattern indicated by the moving signal is consistent with the control signal.

### FIELD OF THE INVENTION

The present invention relates to a motion testing method and a motion testing system, and more particularly to a motion testing method and a motion testing system for testing optical sensing modules.

### BACKGROUND OF THE INVENTION

Generally speaking, a cursor and input control device is an essential peripheral equipment of a computer system, and a mouse device is the most popular one of cursor and input control devices. There are two basic types of mouse devices in current use. The first type is a so-called mechanical mouse, which has a ball on its underside that can roll in all directions. A sensor or encoder of the mouse device detects the rolling direction, speed, and trace of the ball and sends a corresponding moving signal to the host computer. In this way, the host computer can move and locate the screen cursor according to the moving signal.

The other type of mouse device is a so-called optical mouse, which has an optical sensing module mounted on its underside. The sensing module comprises a light source, a photodetector array, and a control circuit. The light source emits a light beam onto the contact surface where the mouse device rests and moves, and the photodetector array receives the image reflected from the contact surface. When the optical mouse is moving, the image received by the photodetector array is moving, too. According to the image shift level, the control circuit calculates the corresponding moving direction, speed, and trace and sends a moving signal to the host computer. In this way, the host computer can move the screen cursor according to the moving signal.

For verifying the accuracy of the moving signal in response to the image change, a motion test is necessary for each mouse product before leaving the factory. The motion test is performed to see whether the moving signal well responds to the moving direction, speed and trace of the mouse device on the contact surface. FIG. 1 shows a conventional motion testing system. The mouse 16 rests on a surface 14 and is held by a clipping device 20 of a control machine 18 to move on the surface 14. The control machine 18 is coupled to the host computer 10 via a signal-transmission line 22 in which a control signal is transmitted from the host computer 10 to have the control machine 18 move so as to carry the mouse device 16 to move according to a preset pattern. In other words, when the mouse device 16 moves with the control machine 18 in response to the control signal, the cursor should move on the screen from a first position through a predetermined trace to a second position. When the mouse device 16 is moving, the moving signal generated by the control circuit of the mouse device is fed back to the host computer 10 via a signal-transmission line 12 to be compared with the preset pattern. If the comparison reveals an unmatched result, the settings of the mouse device 16 will need to be calibrated.

However, the conventional motion testing system is subject to errors for some unstable factors. For example, if the clipping device 20 of the control machine 18 does not tightly clip the mouse device 16, unbalanced movement of the mouse device 16 or poor contact between the mouse device 16 and the surface 14 may be rendered, especially in the test performed under a high moving speed. These adverse factors may result in incorrect moving signal that does not match the issued control signal. Moreover, because of the large size and high cost of the control machine 18, the number of control machines 18 used for testing in a factory is very limited. Therefore, lots of waiting time will be required for testing a large amount of mouse products. The throughput is thus adversely affected.

### SUMMARY OF THE INVENTION

Therefore, the present invention provides a motion testing method and system for testing the mouse devices, which exempts from those unstable factors and allows a plurality of mouse devices to be tested simultaneously.

The present invention provides a motion testing method for testing an optical sensing module. In the method, an external light beam is projected onto the optical sensing module. Relative positions between the external light beam and the optical sensing module are changed in response to a control signal. A moving signal is generated by the optical sensing module according to a change of the relative positions. A test result is realized by comparing the control signal and the moving signal.

In an embodiment, the light beam is an unfocused and broad sectional laser beam. Preferably, the laser beam has a wavelength between 650 nm and 670 nm.

In an embodiment, the optical sensing module remains unmoved and the light beam is moved in response to the control signal to change the relative positions between the external light beam and the optical sensing module.

In an embodiment, the external light beam is emitted by a movable light source that is away from the optical sensing module at a distance between 10 cm and 50 cm.

In an embodiment, the external light beam contains a plurality of speckles projected onto a photodetector array of the optical sensing module, and a control circuit of the optical sensing module generates the moving signal according to a change of the speckles detected by the photodetector array due to the change of the relative positions.

In an embodiment, the control signal is issued by a host computer and the moving signal is transmitted to the host computer to be compared with the control signal. The test result indicates whether a movement pattern controlled by the moving signal is consistent with that controlled by the control signal.

For example, the optical sensing module can be mounted in an optical navigation device such as an optical mouse device.

The present invention also relates to a motion testing method for testing optical sensing modules, comprising steps of: fixing a plurality of optical sensing modules in a specified range; moving a light beam over the specified range in response to a control signal to project the light beam onto the plurality of optical sensing modules; generating a plurality of moving signals according to changes of optical speckles in the light beam received by the plurality of optical sensing modules, respectively; and realizing test results of the plurality of optical sensing modules by comparing respective moving signals with the control signal.

The present invention further relates to a motion testing system for testing at least one optical sensing module. In the system, a host computer is used for issuing a control signal to the at least one optical sensing module, receiving a responsive moving signal from the at least one optical sensing module, and comparing the control signal and the moving signal to realize a test result. A movable light source is coupled to the host computer and moves in response to the control signal for projecting a movable light beam onto the at least one optical sensing module so that the at least one optical sensing module generates the moving signal according to a change of the light beam.

Preferably, the motion testing system further comprises coupling means for keeping the at least one optical sensing module unmoved while the movable light source is moving.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram showing a conventional motion testing system;

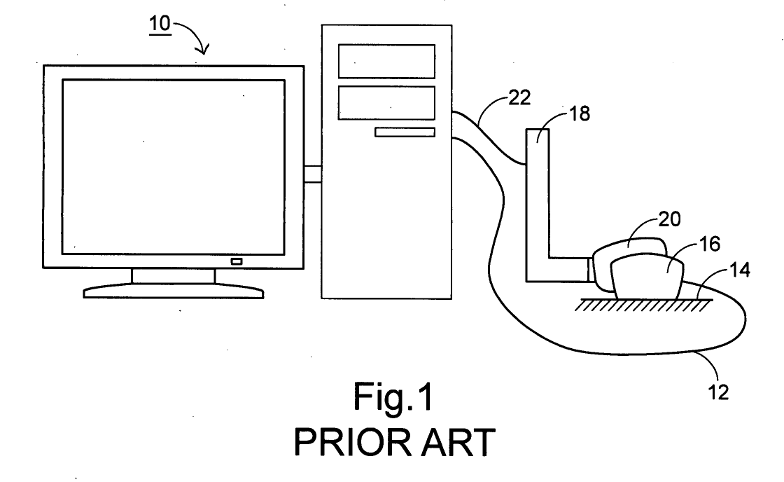

FIG. 2 is a schematic diagram showing an embodiment of a motion testing system according to the present invention; and

FIG. 3 is a schematic diagram showing the use of a motion testing system for testing a plurality of mouse devices at the same time according to the present invention.

### DETAILED DESCRIPTION OF THE PREFERRED EMBODIMENT

As described above, the moving signal is generated by the control circuit according to the image change detected by the photodetector array, which reflects the moving direction, speed and trace of the mouse device. It is understood that the image change results from the relative movement of the mouse device to the contact surface. In contrast to the movement of the mouse device in the prior art to result in image change, the mouse device is fixed and the image change is caused in an alternative manner according to the present invention.

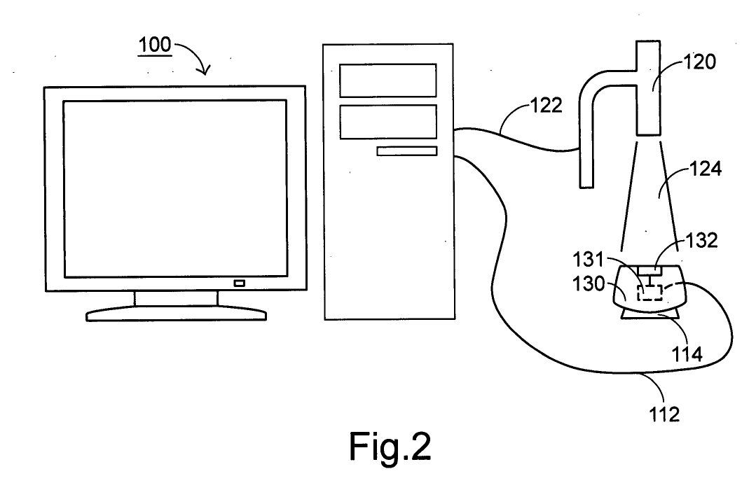

In an embodiment of the present invention, which is illustrated in FIG. 2, the mouse device 130 is fixed with coupling means 114, and a movable laser source 120 is provided above the mouse device 130 to be tested and emits an unfocused and broad sectional laser beam 124 onto the photodetector array 132 of the mouse device 130. Due to optical interference occurring in the laser beam 124, optical speckles are formed and transmitted along with the laser beam 124. These speckles, when projected onto the photodetector array 132, can be seen as some kind of image. When the laser source 120 moves in response to a control signal transmitted from the host computer 100 via the signal-transmission line 122, the optical speckles move, too, so as to result in image change detected by the photodetector array 1132. According to the image change, the moving signal is generated by the control circuit 131 of the mouse device 130 and transmitted to the host computer 100 via the signal-transmission line 112 to be processed. The resulting moving signal is then compared with the original control signal. If the comparison reveals a consistent result, i.e. the moving signal enables the cursor to move on the screen from a first position through a predetermined trace to a second position, just as expected by the host computer through the control signal, it is determined that the output of the mouse device is reliable. Otherwise, the settings of the mouse device 16 will need to be calibrated.

The motion testing system and method illustrated above with reference to FIG. 2 is exemplified to be used with a mouse device. Nevertheless, the present system and method can be applied to any other navigation device containing an optical sensing module for movement control. Further, other types of light instead of laser beam can also be used as long as suitable interfering pattern or moiré pattern, so called “image” can be formed and “image change” can be detected while moving.

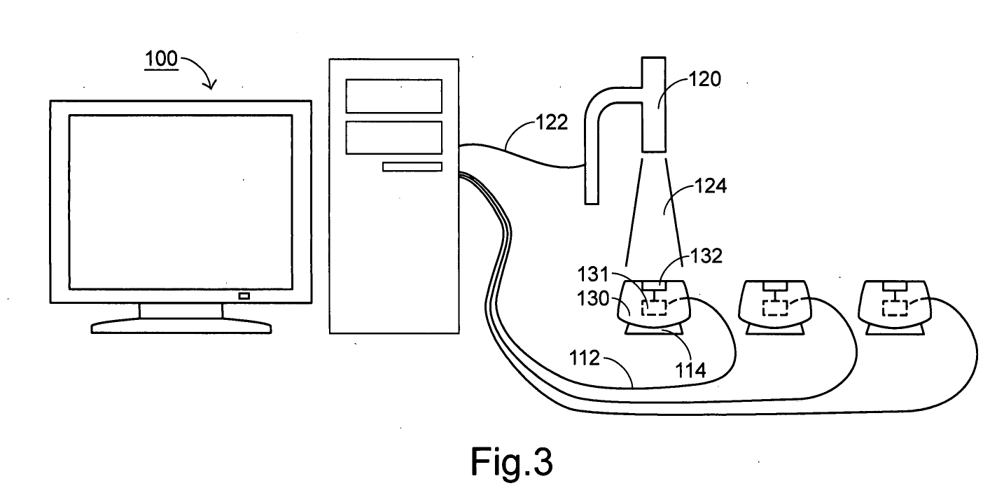

Since it is the laser source instead of the tested device moved according to the present invention, the present motion testing system allows more than one optical sensing modules to be tested at the same time. In other words, by fixing a plurality of optical sensing modules under an accessible range of the movable laser beam and moving the movable laser source over the designated range, the above-mentioned testing operation can be simultaneously performed for all of the optical sensing modules. Under this circumstance, in response to the same control signal, the host computer can receives various moving signals from these optical sensing modules via respective signal transmission lines, as shown in FIG. 3, thereby verifying or calibrating the settings of the devices efficiently.

To have a precise test result, the laser beam preferably has wavelength ranged between 650 nm and 850 nm. Also, the projection distance between the movable light source and the optical sensing module is preferably set between 10 cm and 50 cm.

By using the present motion testing system, the conventional control machine for moving the mouse device will not be required any more. The errors resulting from unbalanced movement and poor contact as mentioned above will be eliminated because no more clipping and moving operations on a specified surface are performed according to the present invention. Furthermore, a plurality of mouse devices can be tested at the same time. Even if the test is performed under a high moving speed, the only factor that has to be considered is to exactly control the movable light source. Hence, the test thus can be done accurately and efficiently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motion testing method for testing an optical sensing module, comprising steps of:
projecting an external light beam onto the optical sensing module;
changing relative positions between said external light beam and the optical sensing module in response to a control signal;
generating a moving signal by the optical sensing module according to a change of said relative positions; and
realizing. a test result by comparing said control signal and said moving signal.

2. The motion testing method according to claim 1 wherein said light beam is an unfocused and broad sectional laser beam.

3. The motion testing method according to claim 2 wherein said laser beam has a wavelength between 650 nm and 670 nm.

4. The motion testing method according to claim 1 wherein the optical sensing module remains unmoved and said light beam is moved in response to said control signal to change said relative positions between said external light beam and the optical sensing module.

5. The motion testing method according to claim 1 wherein said external light beam is emitted by a movable light source that is away from the optical sensing module at a distance between 10 cm and 200 cm.

6. The motion testing method according to claim 1 wherein said external light beam contains a plurality of speckles image projected onto a photodetector array of the optical sensing module, and a control circuit of the optical sensing module generates said moving signal according to a change of said speckles image detected by said photodetector array due to said change of said relative positions.

7. The motion testing method according to claim 1 wherein said control signal is issued by a host computer and said moving signal is transmitted to the host computer to be compared with said control signal.

8. The motion testing method according to claim 7 wherein said test result indicates whether a movement pattern controlled by said moving signal is consistent with that controlled by said control signal.

9. The motion testing method according to claim 1 wherein the optical sensing module is mounted in an optical navigation device.

10. A motion testing method for testing optical sensing modules, comprising steps of:
fixing a plurality of optical sensing modules in a specified range;
moving a light beam over said specified range in response to a control signal to project said light beam onto the plurality of optical sensing modules;
generating a plurality of moving signals according to changes of optical speckles in said light beam received by the plurality of optical sensing modules, respectively; and
realizing test results of the plurality of optical sensing modules by comparing respective moving signals with said control signal.

11. The motion testing method according to claim 10 wherein said light beam is an unfocused and broad sectional laser beam.

12. The motion testing method according to claim 11 wherein said laser beam is emitted by a laser source disposed 10˜200 cm above said specified region and has a wavelength between 650 nm and 850 nm.

13. The motion testing method according to claim 10 wherein said control signal is issued by a host computer and said moving signal is transmitted to the host computer to be compared with said control signal.

14. The motion testing method according to claim 13 wherein said test result indicates whether a movement pattern controlled by said moving signal is consistent with that controlled by said control signal.

15. A motion testing system for testing at least one optical sensing module, comprising:
a host computer for issuing a control signal to the at least one optical sensing module, receiving a responsive moving signal from the at least one optical sensing module, and comparing said control signal and said moving signal to realize a test result; and
a movable light source coupled to said host computer and moving in response to said control signal for projecting a movable light beam onto the at least one optical sensing module so that the at least one optical sensing module generates said moving signal according to a change of said light beam.

16. The motion testing system according to claim 15 wherein said movable light source is a laser source, and said light beam is an unfocused and broad sectional laser beam.

17. The motion testing system according to claim 16 wherein said laser beam has a wavelength between 650 nm and 850 nm, and a distance between said laser source and the at least one optical sensing module is set between 10 cm and 200 cm.

18. The motion testing system according to claim 15 wherein said light beam contains a plurality of speckles projected onto a photodetector array of the at least one optical sensing module, and a control circuit of the at least one optical sensing module generates said moving signal according to a change of said speckles detected by said photodetector array.

19. The motion testing system according to claim 15 wherein said test result indicates whether a movement pattern controlled by said moving signal is consistent with that controlled by said control signal.

20. The motion testing system according to claim 15 further comprising coupling means for keeping the at least one optical sensing module unmoved while said movable light source is moving.
